(19) United States
(12) Patent Application Publication
(10) Pub. No.: US 2026/0081723 A1
(43) Pub. Date: Mar. 19, 2026

(54) SIGNALING THAT INCLUDES INVERSION INFORMATION AND LINK PARITY INFORMATION

(71) Applicant: Micron Technology, Inc., Boise, ID (US)

(72) Inventors: Steffen BUCH, Taufkirchen (DE); Aaron P. BOEHM, Boise, ID (US)

(21) Appl. No.: 19/268,609

(22) Filed: Jul. 14, 2025

Related U.S. Application Data
(60) Provisional application No. 63/694,303, filed on Sep. 13, 2024.

(51) Int. Cl. H04L 1/00; G06F 13/16

(52) U.S. Cl. CPC H04L 1/0084; G06F 13/1678; H04L 1/0063

(57) ABSTRACT

In some implementations, a system may invert, based on an inversion configuration, one or more portions of first data to generate second data. The system may generate link parity information associated with the second data and the inversion configuration. The system may communicate, from a host system to a memory apparatus and via a first bus of a host interface, a message comprising the second data, the inversion configuration, and the link parity information from the host system to the memory apparatus. The system may store the second data to one or more memory arrays of the memory apparatus.

### CROSS-REFERENCE TO RELATED APPLICATION

This Patent Application claims priority to U.S. Provisional Patent Application No. 63/694,303, filed on Sep. 13, 2024, entitled “SIGNALING THAT INCLUDES INVERSION INFORMATION AND LINK PARITY INFORMATION,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to signaling that includes inversion information and link parity information.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of signaling that includes inversion information and link parity information.

FIG. 2 shows an example of a system that supports signaling that includes inversion information and link parity information.

FIG. 3 shows an example of a data packet that supports signaling that includes both inversion information and link parity information.

FIGS. 4A and 4B are diagrams of an example of signaling that includes inversion information and link parity information.

FIG. 5 is a flowchart of an example method associated with signaling that includes inversion information and link parity information.

FIG. 6 is a flowchart of an example method associated with signaling that includes inversion information and link parity information.

FIG. 7 is a flowchart of an example method associated with signaling that includes inversion information and link parity information.

### DETAILED DESCRIPTION

Some systems may operate according to a protocol that supports a write burst mode in which a host system communicates a data packet to a memory system. The memory system may store a payload (e.g., user data) included in the data packet to one or more memory devices of the memory system. The data packet may further include control information associated with the payload, such as metadata generated by the host system, sometimes referred to as system metadata, and/or communication control information associated with communicating the data packet. Such communication control information may be used to improve the reliability of communicating the data packet. For example, the communication control information may include link parity information. Link parity information may be parity information (e.g., one or more error correction codes (ECCs) and/or one or more error detection codes (EDCs)) used to detect and/or correct one or more errors in the data packet that occur during communication (e.g., transmission and/or reception) of the data packet between the host system and the memory system.

For example, to communicate a data packet from the host system to the memory system, the host system may generate link parity information using the payload and/or system metadata associated with the payload. The host system may provide the data packet, which may include the payload, the system metadata, and the link parity information, to the memory system. After obtaining the data packet, the memory system may detect and/or correct one or more errors in the payload and the system metadata using the link parity information. The memory system may then store the payload and system metadata to the one or more memory devices.

Alternatively, in some cases, the communication control information may include an inversion configuration associated with the payload and/or the system metadata. An inversion configuration may include one or more bits, where each bit indicates whether a respective portion of the payload is to be inverted as part of a data bus inversion (DBI) operation. The host system and/or the memory system may encode a payload according to an inversion configuration to improve the integrity and/or efficiency of communicating the payload. For example, the inversion configuration may be selected to mitigate the duration that pins of the data bus are driven to a high voltage state (e.g., by mitigating the quantity of logical “1s” in the payload), which may reduce power consumption. Additionally, or alternatively, the inversion configuration may be selected to mitigate the variance in the payload, such as by reducing the quantity of transitions between a high voltage state and a low voltage state of pins of the data bus, which may reduce noise or other interference.

However, some communication protocols may not allow the system to include both link parity information and an inversion configuration in a data packet. For example, some communication protocols may provision a fixed quantity of bits of the data packet to be used for communication control information. Such a fixed quantity of bits may allow including the link parity information or the inversion configuration, but not both, thus increasing power consumption, reducing signal integrity, and/or increasing the likelihood of errors occurring during communication of the data packet.

Some implementations described herein enable signaling that includes both inversion information and link parity information. For example, a host system may encode a payload of a data packet, such as by inverting one or more portions of the payload in accordance with an inversion configuration. As described in greater detail elsewhere herein, the host system may place the inversion configuration and, in some examples, additional system metadata, in a first one or more portions of the data packet provisioned for system metadata. The host system may generate link parity information for the encoded payload, the inversion configuration, and/or the additional system metadata to be included in the data packet. For example, the host system may generate the link parity information by performing one or more error control operations on the encoded payload, the inversion configuration, and/or the additional system metadata. The host system may place the link parity information in a second one or more portions of the data packet provisioned for communication control information. The host system may provide, and a memory system may obtain, a data packet that includes the encoded payload, the inversion configuration, the link parity information, and/or the additional system metadata.

Based on, in response to, or otherwise associated with obtaining the data packet, the memory system may perform an error control operation on the data packet using the link parity information. For example, the memory system may use the link parity information to correct and/or detect one or more errors in the encoded payload, the inversion configuration, and/or the additional system metadata (e.g., errors that occurred during transmission of the data packet between the host system and the memory system). The memory system may store all or a portion of the data packet to one or more memory devices of the memory system. For example, the memory system may store the encoded payload to one or more first memory arrays associated with user data. Further, the memory system may store the inversion configuration and/or the additional system metadata to one or more second memory arrays associated with metadata corresponding to the encoded payload.

To read the payload, the host system may provide, and the memory system may obtain, one or more commands to retrieve the encoded payload, the inversion configuration, and/or the additional system metadata. The memory system may provide the encoded payload, the inversion configuration, and the additional system metadata to the host system. The host system may decode the encoded payload, such as by reinverting the one or more portions of the encoded payload in accordance with the inversion configuration.

As a result, by enabling signaling that includes inversion information and link parity information, the host system may improve the signal quality and data reliability during transmission of a data packet between the host system and the memory system. For example, by using portions of the data packet provisioned for system metadata to communicate an inversion configuration, the host system may use the inversion configuration to encode the payload of the data packet and thus improve the integrity and/or reduce the power consumption of signals communicated between the host system and the memory system. Additionally, the host system may use portions of the data packet provisioned for communication control information to communicate link parity information, which may reduce the likelihood of errors occurring during transmission of the data packet.

Further, because the encoded payload may have a reduced quantity of logical “1”s, the memory system may reduce power consumption and/or reduce the likelihood of errors occurring during storage of the encoded payload. For example, because the power used to store a logical “1” may be greater than the power used to store a logical “0”, storing the encoded payload may use less power compared with storing the unencoded payload. Further, because an error (e.g., a bit-flip) may be more likely to occur in a memory cell storing a logical “1” compared with a memory cell storing a logical “0”, storing the encoded payload may reduce the likelihood of errors.

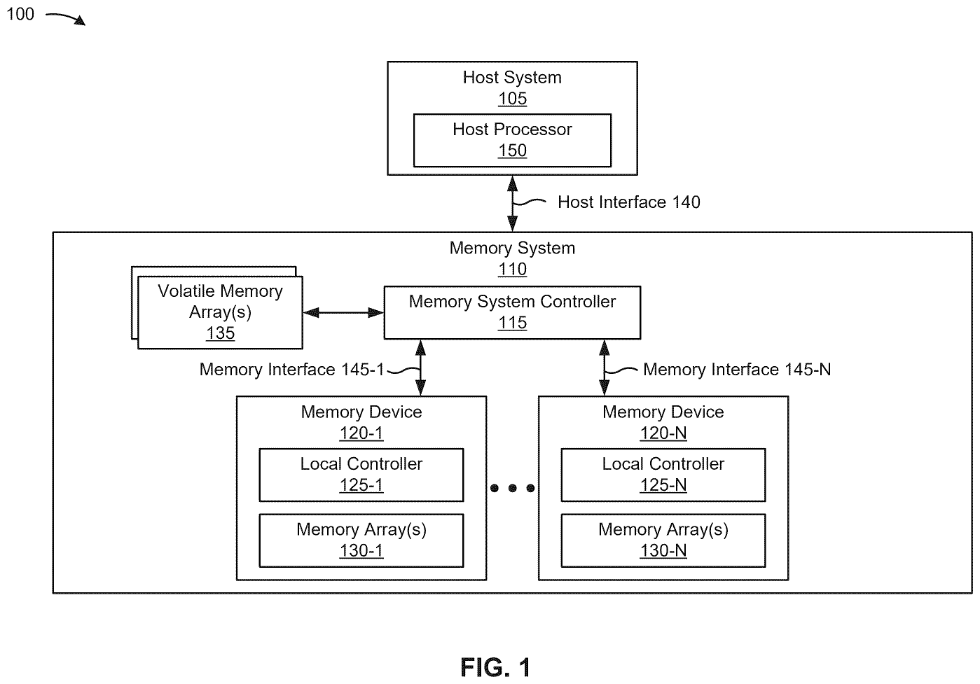

FIG. 1 is a diagram illustrating an example system 100 capable of signaling that includes inversion information and link parity information. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller.

Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to invert, based on an inversion configuration, one or more portions of first data to generate second data; generate link parity information associated with the second data and the inversion configuration; and provide, to a memory system and via a first bus, a message comprising the second data, the inversion configuration, and the link parity information.

In some implementations, one or more systems, devices, apparatuses, components, and/or controllers of FIG. 1 may be configured to: obtain, from a host system and via a first bus, a message comprising data, an inversion configuration, and link parity information; perform, using the link parity information, an error correction operation on the data and the inversion configuration; and invert, based on the inversion configuration, one or more portions of the data to generate second data.

In some implementations, one or more systems, devices, apparatuses, components, and/or controllers of FIG. 1 may be configured to: invert, based on an inversion configuration, one or more portions of first data to generate second data; generate link parity information associated with the second data and the inversion configuration; communicate, from a host system to a memory apparatus and via a first bus of a host interface, a message comprising the second data, the inversion configuration, and the link parity information from the host system to the memory apparatus; and store the second data to one or more memory arrays of the memory apparatus.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

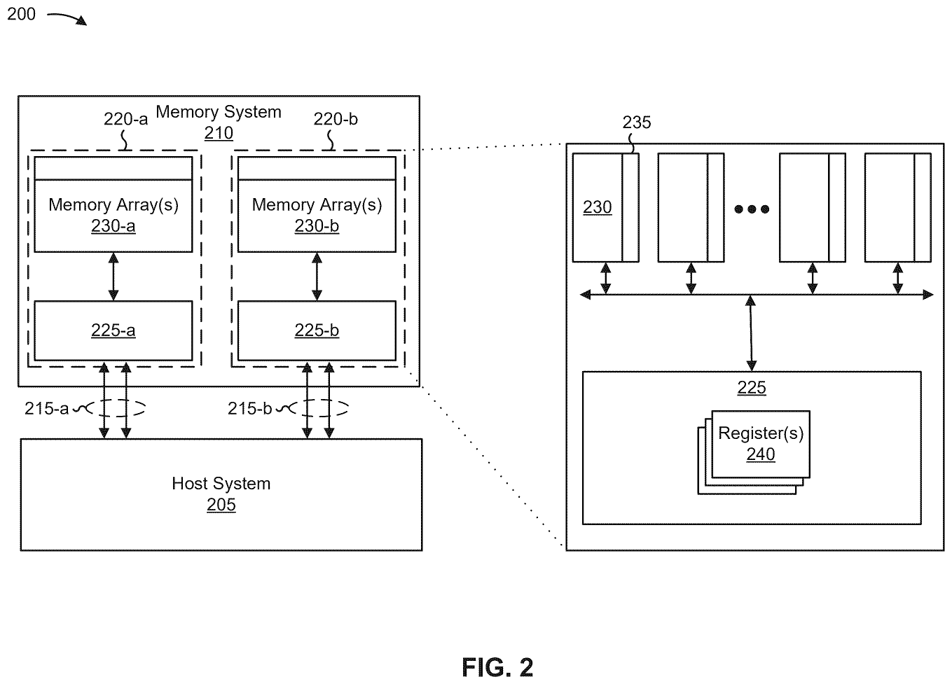

FIG. 2 shows an example of a system 200 that supports signaling that includes inversion information and link parity information. The system 200 may be an example of or may include aspects of the system 100. For example, the system 200 may include a host system 205, which may be an example of a host system 105, and a memory system 210, which may be an example of a memory system 110. The host system 205 and the memory system 210 may communicate signaling using an interface 215, which may be an example of or may include aspects of a host interface 140. For example, the interface 215 may include one or more buses, such as a control/address (C/A) bus and a data (DQ) bus. The system 200 may use the C/A bus to communicate command signals and/or address information between the host system 205 and the memory system 210. The system 200 may use the DQ bus to transmit data, including write data, read data, and/or system metadata associated with the data.

The memory system 210 may include one or more memory devices 220 having respective sub-interfaces 225 that support communication with the host system 205 via a respective interface 215, such as a memory device 220-a having a sub-interface 220-a coupled to an interface 215-a and/or a memory device 220-b having a sub-interface 225-b coupled to an interface 215-b. A sub-interface 225 may facilitate communication between a memory device 220 and the host system 205, enabling the transfer of read and write commands, data, and control signals. In some implementations, a memory device 220 may include different types of memory, such as NAND flash memory, DRAM, or other memory technologies.

In some implementations, a memory device 220 may include one or more memory arrays 230, such as one or more banks of memory cells, one or more sub-arrays of memory cells, one or more blocks of memory cells, and/or one or more planes of memory cells, among other examples. The memory device 220 may be configured to store a payload of a data packet (e.g., user data) to the one or more memory arrays 230. For example, the memory device 220 may store data across multiple memory arrays 230 to facilitate parallel access and improve data transfer speeds. Additionally, the memory device 220 may organize data storage at a granular level, such as storing data in pages or sub-pages within each block or sub-array. Further, the memory device 220 may utilize data management techniques, such as wear leveling or bad block management, to allocate data to the memory arrays 230 in order to enhance the reliability and longevity of memory cells of the memory arrays 230.

In some implementations, a memory device 220 may include one or more memory arrays 235 used to store system metadata, such as one or more banks of memory cells, one or more arrays of memory cells, one or more sub-arrays of memory cells, one or more blocks of memory cells, and/or one or more planes of memory cells, among other examples. Such memory arrays 235 may also be referred to as “carve-out” portions of a memory device 220. System metadata may include information associated with data management and integrity provided by the host system 205, such as parity information, version numbers, timestamps, and/or data structure descriptors, among other examples. In some implementations, the system metadata may also include flags or indicators specifying the type of data stored, access control information, and/or history logs for tracking access operations. Such system metadata may be used to enhance data robustness and reliability by providing additional context needed for data reconstruction and validation processes.

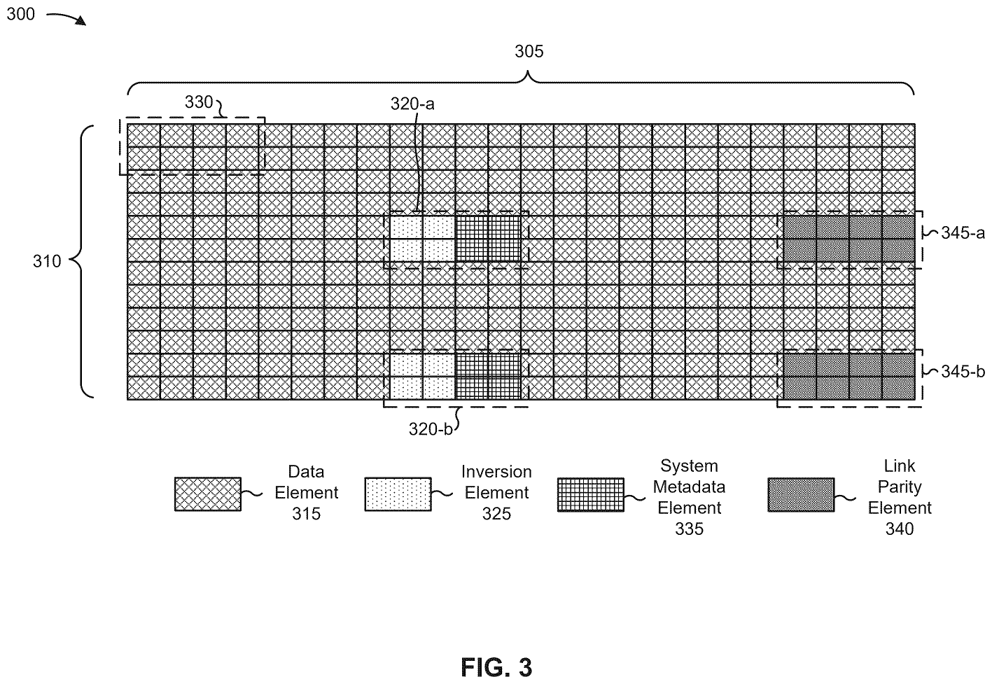

The memory device 220 may be configured to store system metadata associated with the data packet to the one or more memory arrays 235. As described in greater detail in connection with FIG. 3, a data packet may include one or more portions provisioned for system metadata. After receiving a data packet, the memory system 210 may temporarily buffer information located in the one or more portions to one or more registers 240 of a sub-interface 225. In some examples, the host system 205 may provide a command (e.g., via a C/A bus) to store the information buffered in the one or more registers 240. In such examples, the memory system 210 may transfer the information in the one or more registers 240 to the one or more memory arrays 235.

The host system 205 may write data to the memory system 210 by providing one or more data packets to the memory system (e.g., as part of a write burst operation). For example, the host system 205 may provide a write command to the memory system 210 (e.g., via a C/A bus) indicating that the memory system 210 is to store the data. The host system 205 may segment a data message into multiple data packets, each of which may be transmitted to the memory system 210 (e.g., via a DQ bus) during the write burst. Each data packet may contain a portion of the data, as well as associated metadata, such as link parity information and/or inversion information.

The host system 205 may encode a payload of a data packet, such as by inverting one or more portions of the payload in accordance with an inversion configuration. The host system 205 may place the inversion configuration and, in some examples, additional system metadata, in a first one or more portions of the data packet provisioned for system metadata. The host system 205 may generate link parity information for the encoded payload, the inversion configuration, and/or the additional system metadata to be included in the data packet. For example, the host system 205 may generate the link parity information by performing one or more error control operations on the encoded payload, the inversion configuration, and/or the additional system metadata. The host system 205 may place the link parity information in a second one or more portions of the data packet provisioned for communication control information. The host system 205 may provide, and the memory system 210 may obtain, a data packet that includes the encoded payload, the inversion configuration, the link parity information, and/or the additional system metadata.

Based on, in response to, or otherwise associated with obtaining the message, the memory system 210 may perform an error control operation on the data packet using the link parity information. The memory system 210 may store all or a portion of the data packet to the one or more memory arrays 230. Further, the memory system 210 may store the inversion configuration and/or the additional system metadata to the one or more memory arrays 235.

To read the payload, the host system 205 may provide, and the memory system 210 may obtain, one or more commands to retrieve the encoded payload, the inversion configuration, and/or the additional system metadata. The memory system 210 may provide the encoded payload, the inversion configuration, and the additional system metadata to the host system 205. The host system 205 may decode the encoded payload, such as by reinverting the one or more portions of the encoded payload in accordance with the inversion configuration.

In some implementations, the memory system 210 may decode the encoded payload prior to storing the payload to the one or more memory arrays 230. For example, after detecting and/or correcting one or more errors in the encoded payload, the memory system 210 may invert (e.g., reinvert) the one or more portions of the encoded payload in accordance with the inversion configuration. The memory system 210 may store the decoded payload to the one or more memory arrays 230. In such implementations, the memory system 210 may refrain from storing the inversion configuration to the one or more memory arrays 235 (e.g., the memory system 210 may discard the inversion configuration).

To read the payload in such implementations, the host system 205 may provide, and the memory system 210 may obtain, one or more commands to retrieve the payload. The memory system 210 may retrieve the payload, and may encode the payload using a second inversion configuration (e.g., an inversion configuration generated by the memory system 210). The memory system 210 may generate second link parity information for the encoded payload and the second inversion configuration. For example, the memory system 210 may generate the second link parity information by performing one or more error control operations on the encoded payload and the second inversion configuration. The memory system 210 may provide, and the host system 205 may obtain, a second data packet that includes the encoded payload, the second inversion configuration, and the link parity information. The host system 205 may detect and/or correct one or more errors in the second data packet using the second link parity information. Additionally, the host system 205 may decode the encoded payload using the second inversion configuration.

As indicated above, FIG. 2 is provided as an example. Other examples may differ from what is described with regard to FIG. 2.

FIG. 3 shows an example of a data packet 300 that supports signaling that includes both inversion information and link parity information. The data packet 300 may illustrate a format of signaling communicated between a host system (e.g., the host system 205) and a memory system (e.g., the memory system 210) specified by a communication protocol, such as a format used for a write burst operation.

The data packet 300 may include one or more elements arranged according to one or more time intervals 305, which may be referred to as “beats”, and one or more pins 310 of a bus (e.g., an interface 215) between the host system and the memory system. Said another way, each pin 310 of bus may communicate a single element between the host system and the memory system during each time interval 305. An element corresponding to a given time interval 305 and a given pin 310 may represent a voltage level of the given pin 310 during the given time interval 305. For example, an element may be a single bit, such as a high state (e.g., a logic “1) or a low state (e.g., a logic “0”) at an edge (e.g., a rising edge, a falling edge) of a clock signal used as part of binary signaling. Additionally, or alternatively, an element may correspond to a voltage level of other signaling schemes, such as non-return-to-zero (NRZ) signaling, three-level pulse-amplitude modulation (PAM-3) signaling, and/or PAM-4 signaling, among other examples.

The one or more elements may include one or more data elements 315. The one or more data elements 315 of the data packet may represent the payload of the data packet 300, such as user data communicated between the host system and the memory system.

In some examples, the communication protocol may specify one or more locations 320 (e.g., one or more subsets of the time intervals 305 and/or the pins 310, one or more portions of the data packet 300) within the data packet 300 to include control information associated with the payload of the data packet 300. For example, the communication protocol may specify that system metadata may be included at a location 320-a and/or a location 320-b, as illustrated in FIG. 3. Said another way, the communication protocol may provision the locations 320 for system metadata. As described in greater detail in connection with FIG. 2, the memory system may store information in the locations 320 to one or more memory arrays provisioned for system metadata.

The host system and/or the memory system may use the locations 320 to communicate an inversion configuration. For example, the inversion configuration may include one or more inversion elements 325 (e.g. one or more bits). Each inversion element 325 may correspond to a respective portion 330 of the data elements 315 and may indicate whether the data elements 315 of the respective portion 330 are to be inverted. Inverting a data element 315 may include changing the state of the data element 315. For example, if a data element 315 includes a logic “1”, then inverting the data element 315 may include changing the data element 315 to include a logic “0”. Alternatively, if a data element 315 includes a logic “0”, then inverting the data element 315 may include changing the data element 315 to include a logic “1”.

By way of example, if a given inversion element 325 corresponding to a given portion 330 is a first value (e.g., a logic “1”), then encoding the data packet 300 may include inverting each data element 315 of the portion 330. Alternatively, if the inversion element 325 is a second value (e.g., a logic “0”), then encoding the data packet 300 may include refraining from inverting each data element 315 of the portion 330. The host system and/or the memory system may determine the inversion configuration to mitigate power consumption and/or signal interference, such as by mitigating the quantity of logical “1s” in the data packet 300 (which may reduce power consumption) and/or by mitigating variance in the data packet 300, such as by reducing the quantity of transitions between a high signal state and a low signal state of a pin 310. In some implementations, the inversion configuration may be dynamically determined based on real-time assessment of the payload of the data packet 300 and/or performance of the one or more pins 310.

In some cases, the host system may include one or more additional system metadata elements 335 in the locations 320. For example, the host system may include additional parity information or other system metadata to improve the reliability of the data packet 300. To allow for such additional system metadata elements 335, the host system may reduce the quantity of inversion elements 325 of the inversion configuration. In such examples, the host system may adjust the size (e.g., quantity of elements) and/or arrangement of the portions 330 in accordance with the quantity of inversion elements 325. By way of example, if a first inversion configuration includes twice as many inversion elements 325 compared to a second inversion configuration, then portions 330 corresponding to the first inversion configuration may be half the size of portions 330 corresponding to the second inversion configuration.

Additionally, the communication protocol may specify that communication control information, such as link parity information having one or more link parity elements 340, may be included at a location 345-a and/or 345-b, as illustrated in FIG. 3. Said another way, the communication protocol may provision the locations 345 for communication control information. By way of example, as part of generating the data packet 300 for a write burst operation, the host system may generate the link parity elements 340 by performing an error control operation on the one or more data elements 315, as well as the information in the locations 320 (e.g., as well as the one or more inversion elements 325 and/or the one or more system metadata elements 335). Said another way, the link parity information may be an ECC of the error control operation. The host system may place the link parity elements 340 in the locations 345. After obtaining the data packet 300, the memory system may use the link parity elements 340 to detect and/or correct one or more errors in the data packet 300. As shown in FIG. 3, the one or more pins 310 may include a pin 310 used to communicate a subset of the one or more data elements 315, a subset of the one or more inversion elements 325, a subset of the one or more link parity elements 340, and, in some cases, a subset of the one or more system metadata elements 335.

As indicated above, FIG. 3 is provided as an example. Other examples may differ from what is described with regard to FIG. 3.

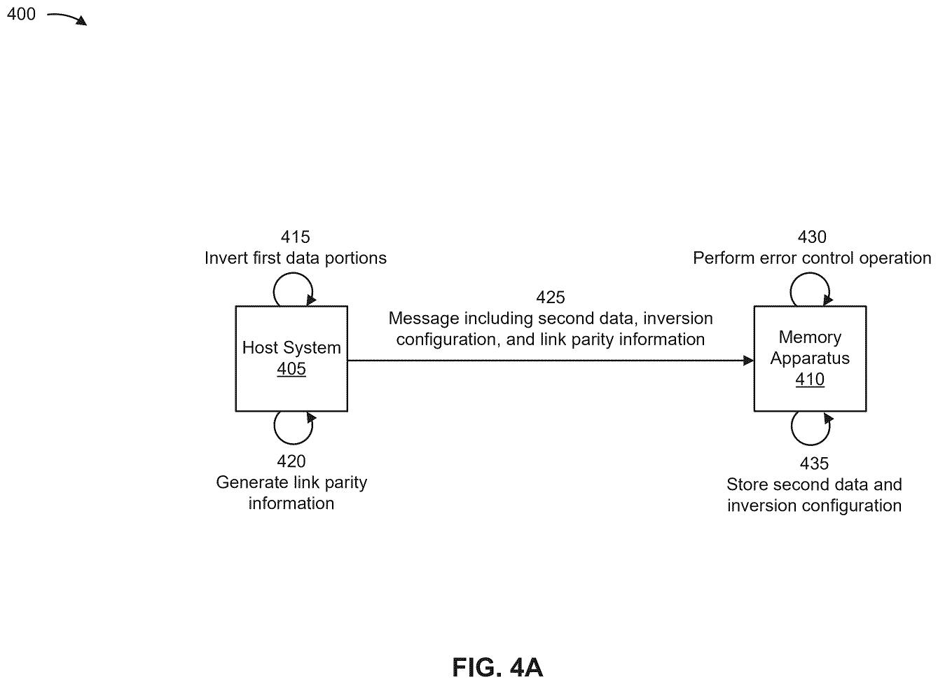

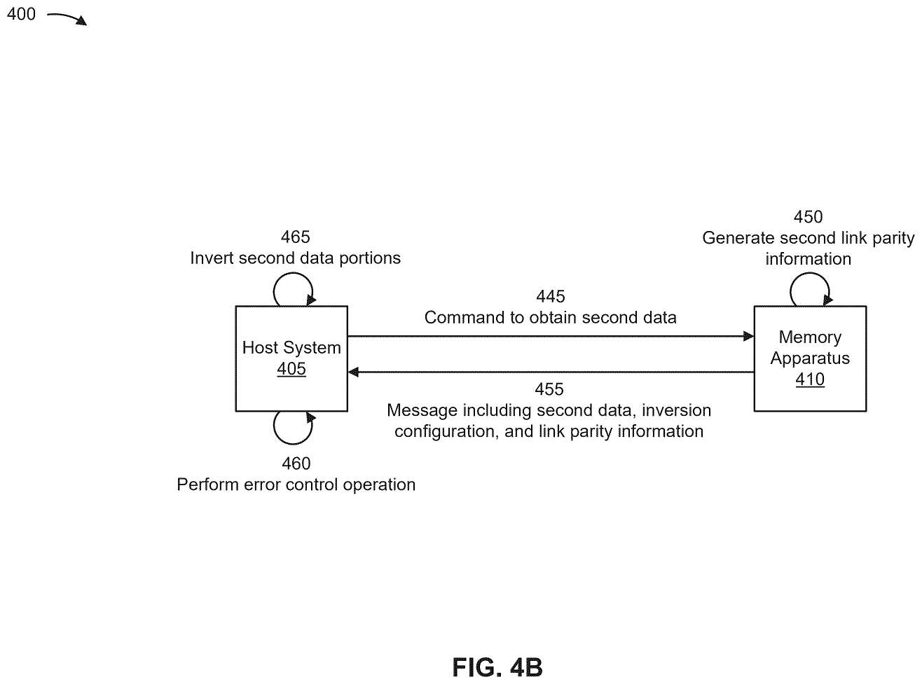

FIGS. 4A and 4B are diagrams of an example 400 of signaling that includes inversion information and link parity information. The operations described in connection with FIGS. 4A and 4B may be performed by a system, such as the system 100, the system 200, and/or one or more components thereof, such as the host system 105, the host system 205, the host interface 140, one or more interfaces 215, the memory system 110, the memory system controller 115, one or more memory devices 120, one or more local controllers 125, and/or the memory system 210.

As shown in FIGS. 4A and 4B, the example 400 may include a host system 405 and a memory apparatus 410. The host system 405 may be the host system 105 and/or the host system 205. The memory system 210 may be or may include the memory system 210, the memory system 110, one or more memory devices 120, and/or one or more controllers (e.g., the memory system controller 115 and/or one or more local controllers 125).

The example 400 may illustrate a process to enable the host system 405 to protect a payload (e.g., first data) to be stored to the memory apparatus 410 using both an inversion configuration and link parity information.

As shown in FIG. 4A, and by reference number 415, the host system 405 may encode the payload to generate an encoded payload (e.g., second data), such as by inverting one or more portions of the payload in accordance with an inversion configuration, as described in greater detail in connection with FIG. 3. In some implementations, the host system 405 may determine the inversion configuration based on the payload. For example, the host system 405 may determine an inversion configuration such that transmitting the encoded payload via the interface uses fewer transitions (e.g., fewer changes between signal logic states) compared to transmitting the unencoded payload.

As shown by reference number 420, the host system 405 may generate link parity information for the encoded payload, the inversion configuration, and/or additional system metadata. For example, as described in greater detail in connection with FIG. 3, the host system 405 may generate the link parity information by performing one or more error control operations on the encoded payload, the inversion configuration, and the additional system metadata. As shown by reference number 425, the host system 405 may provide, and the memory apparatus 410 may obtain, a message that includes the encoded payload, the inversion configuration, the link parity information, and/or the additional system metadata. For example, the message may include or may be a data packet (e.g., a data packet 300) that includes the encoded payload, the inversion configuration, the link parity information, and/or the additional system metadata. In some examples, the host system 405 may provide the message via a first bus (e.g., a DQ bus of an interface 215).

As shown by reference number 430, based on, in response to, or otherwise associated with obtaining the message, the memory apparatus 410 may perform an error control operation on the data packet using the link parity information. For example, the memory apparatus 410 may use the link parity information to correct and/or detect one or more errors in the encoded payload, the inversion configuration, and/or the additional system metadata (e.g., errors that occurred during transmission of the data packet between the host system 405 and the memory apparatus 410).

As shown by reference number 435, the memory apparatus 410 may store all or a portion of the data packet to one or more memory devices of the memory apparatus. For example, the memory apparatus 410 may store the encoded payload to one or more first memory arrays associated with user data (e.g., one or more memory arrays 230). Further, the memory apparatus 410 may store the inversion configuration to one or more second memory arrays associated with metadata corresponding to the encoded payload (e.g., the one or more memory arrays 235).

By including both the inversion configuration and the link parity information in the data packet, the host system 405 may improve the signal quality and data reliability during transmission of the data packet. For example, by using portions of the data packet provisioned for system metadata to communicate the inversion configuration, the host system 405 may use the inversion configuration to encode the payload of the data packet, and thus improve the integrity and/or reduce the power consumption of communicating the data packet. Additionally, by using portions of the data packet provisioned for communication control information to communicate the link parity information, the host system 405 may reduce the likelihood of errors occurring during transmission of the data packet.

In some examples, the memory apparatus 410 may store the inversion configuration and/or the additional system metadata based on, in response to, or otherwise associated with a command from the host system 405. For example, after obtaining the message from the host system 405, the memory apparatus 410 may temporarily store the inversion configuration and/or the additional system metadata to one or more registers (e.g., the one or more registers 240). In such examples, the host system 405 may provide, and the memory apparatus 410 may obtain, the command. In response to the command, the memory apparatus 410 may transfer the inversion configuration and/or the additional system metadata from the one or more registers to the one or more second memory arrays. In some examples, the host system 405 may provide the command via a second bus (e.g., a C/A bus of an interface 215). In some implementations, after performing the error control operation, the memory apparatus 410 may discard the link parity information. Said another way, after performing the error control operation, the memory apparatus 410 may refrain from storing the link parity information to the one or more first memory arrays and/or the one or more second memory arrays.

By storing the encoded payload, the memory apparatus 410 may reduce power consumption and/or reduce the likelihood of errors occurring during storage. For example, because the power used to store a logical “1” may be greater than the power used to store a logical “0”, storing the encoded payload may use less power compared with storing the unencoded payload. Further, because an error (e.g., a bit-flip) may be more likely to occur in a memory cell storing a logical “1” compared with a memory cell storing a logical “0”, storing the encoded payload may reduce the likelihood of errors.

As shown in FIG. 4B, the example 400 may further illustrate a process to enable the host system 405 to retrieve the encoded payload, the inversion configuration, and/or the additional system metadata from the memory apparatus 410. For example, as shown by reference number 445, the host system 405 may provide, and the memory apparatus 410 may obtain, a second command (e.g., via the second bus) to retrieve the encoded payload stored in connection with operations associated with reference number 435.

Based on, in response to, or otherwise associated with obtaining the second command, the memory apparatus 410 may retrieve the encoded payload from the one or more devices. In some examples, the memory apparatus 410 may retrieve the inversion configuration and/or the additional system metadata in response to the second command. For example, the second command may indicate or may be a read request for the encoded payload, the inversion configuration, and/or the additional system metadata. Alternatively, the host system 405 may provide a separate command (e.g., a third command provided via the second bus) to retrieve the inversion configuration and/or the additional system metadata

As shown by reference number 450, the memory apparatus 410 may generate second link parity information for the encoded payload, the inversion configuration, and/or the additional system metadata. For example, the memory apparatus 410 may generate the second link parity information by performing one or more error control operations on the encoded payload, the inversion configuration, and the additional system metadata. As shown by reference number 455, the memory apparatus 410 may provide, and the host system 405 may obtain, a second message that includes the encoded payload, the inversion configuration, the second link parity information, and/or the additional system metadata. For example, the message may include or may be a second data packet that includes the encoded payload, the inversion configuration, the second link parity information, and/or the additional system metadata. In some examples, the memory apparatus 410 may provide the second message via the first bus.

As shown by reference number 460, based on, in response to, or otherwise associated with obtaining the second message, the host system 405 may perform an error control operation on the second data packet using the second link parity information. For example, the host system 405 may use the second link parity information to correct and/or detect one or more errors in the encoded payload, the inversion configuration, and/or the additional system metadata (e.g., errors that occurred during transmission of the data packet between the memory apparatus 410 and the host system 405). As shown by reference number 465, the host system 405 may decode the encoded payload (e.g., the generate third data), such as by reinverting the one or more portions of the encoded payload in accordance with the inversion configuration, as described in greater detail in connection with FIG. 3.

As indicated above, FIGS. 4A and 4B are provided as an example. Other examples may differ from what is described with regard to FIGS. 4A and 4B.

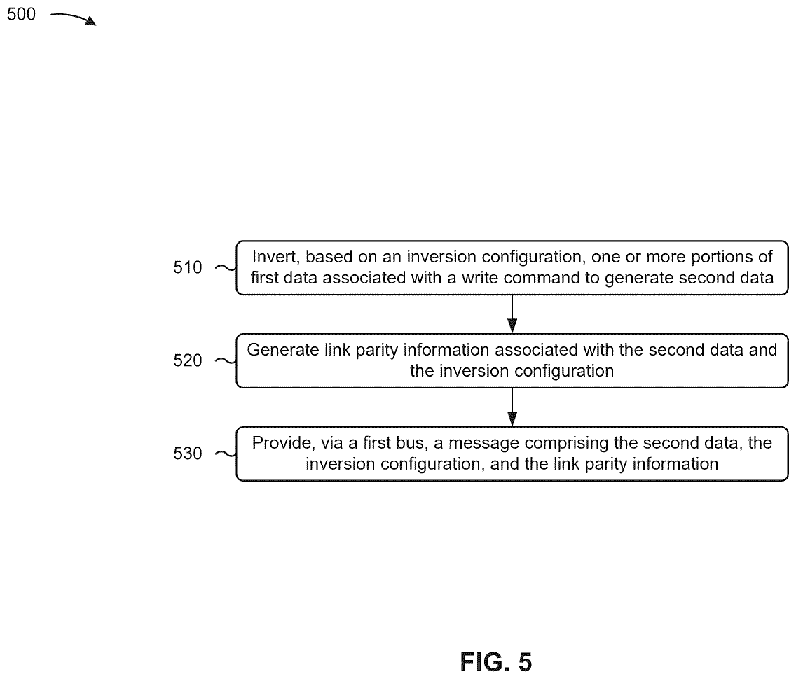

FIG. 5 is a flowchart of an example method 500 associated with signaling that includes inversion information and link parity information. In some implementations, a host system (e.g., the host system 105, a host system 205, and/or a host system 405) may perform or may be configured to perform the method 500. In some implementations, another device or a group of devices separate from or including the host system (e.g., a memory system 110, a memory system controller 115, one or more memory devices 120, one or more local controllers 125, one or more memory arrays 130, a host interface 140, one or more memory interfaces 145, a memory system 210, one or more interfaces 215, one or more memory devices 220, one or more sub-interfaces 225, one or more memory arrays 230, one or more memory arrays 235, one or more registers 240, and/or a memory apparatus 410) may perform or may be configured to perform the method 500. Additionally, or alternatively, one or more components of the host system (e.g., a host processor 150) may perform or may be configured to perform the method 500. Thus, means for performing the method 500 may include the host system and/or one or more components of the host system. Additionally, or alternatively, a non-transitory computer-readable medium may store one or more instructions that, when executed by the host system, cause the host system to perform the method 500.

As shown in FIG. 5, the method 500 may include inverting, based on an inversion configuration, one or more portions of first data associated with a write command to generate second data (block 510). As further shown in FIG. 5, the method 500 may include generating link parity information associated with the second data and the inversion configuration (block 520). As further shown in FIG. 5, the method 500 may include providing, via a first bus, a message comprising the second data, the inversion configuration, and the link parity information (block 530).

The method 500 may include additional aspects, such as any single aspect or any combination of aspects described below and/or described in connection with one or more other methods or operations described elsewhere herein.

In a first aspect, the method 500 includes providing, to the memory system, a command indicating that the memory system is to store the inversion configuration to a location associated with metadata corresponding to the second data.

In a second aspect, alone or in combination with the first aspect, the method 500 includes providing, to the memory system and via a second bus, a command indicating that the memory system is to provide the second data and the inversion configuration to the host system, and obtaining, from the memory system and via the first bus, a second message comprising the second data and the inversion configuration.

In a third aspect, alone or in combination with one or more of the first and second aspects, the method 500 includes reinverting the one or more portions of the second data based on the inversion configuration.

In a fourth aspect, alone or in combination with one or more of the first through third aspects, the second message further comprises second link parity information associated with the second data and the inversion configuration, and the method 500 includes performing, using the second link parity information, an error control operation on the second data and the inversion configuration.

In a fifth aspect, alone or in combination with one or more of the first through fourth aspects, the method 500 includes providing, to the memory system and via a second bus different than the first bus, a command indicating that the memory system is to store the second data.

In a sixth aspect, alone or in combination with one or more of the first through fifth aspects, the inversion configuration comprises one or more bits indicating whether respective portions of the one or more portions of the first data are to be inverted.

In a seventh aspect, alone or in combination with one or more of the first through sixth aspects, the first bus comprises one or more pins, and providing the message to the memory system comprises transmitting a subset of the second data to the memory system via a first pin of the one or more pins, and transmitting a subset of the inversion configuration to the memory system via the first pin.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

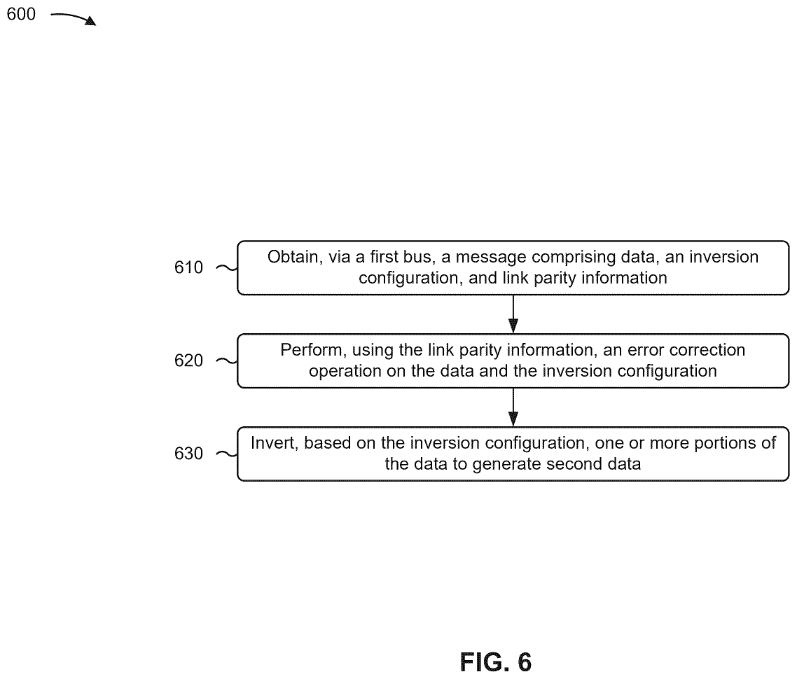

FIG. 6 is a flowchart of an example method 600 associated with signaling that includes inversion information and link parity information. In some implementations, a memory system (e.g., the memory system 110, the memory system 210, and/or the memory apparatus 410) may perform or may be configured to perform the method 600. In some implementations, another device or a group of devices separate from or including the memory system (e.g., the host system 105, the host interface 140, the host system 205, one or more interfaces 215, and/or the host system 405) may perform or may be configured to perform the method 600. Additionally, or alternatively, one or more components of the memory system (e.g., a memory system controller 115, one or more memory devices 120, one or more local controllers 125, one or more memory arrays 130, one or more memory interfaces 145, one or more memory devices 220, one or more sub-interfaces 225, one or more memory arrays 230, one or more memory arrays 235, and/or one or more registers 240) may perform or may be configured to perform the method 600. Thus, means for performing the method 600 may include the memory system and/or one or more components of the memory system. Additionally, or alternatively, a non-transitory computer-readable medium may store one or more instructions that, when executed by the memory system, cause the memory system to perform the method 600.

As shown in FIG. 6, the method 600 may include obtaining, via a first bus, a message comprising data, an inversion configuration, and link parity information (block 610). As further shown in FIG. 6, the method 600 may include performing, using the link parity information, an error correction operation on the data and the inversion configuration (block 620). As further shown in FIG. 6, the method 600 may include inverting, based on the inversion configuration, one or more portions of the data to generate second data (block 630).

The method 600 may include additional aspects, such as any single aspect or any combination of aspects described below and/or described in connection with one or more other methods or operations described elsewhere herein.

In a first aspect, the method 600 includes storing the second data to one or more memory arrays of the memory system.

In a second aspect, alone or in combination with the first aspect, the method 600 includes refraining from storing the link parity information to the one or more memory arrays.

In a third aspect, alone or in combination with one or more of the first and second aspects, the method 600 includes refraining from storing the inversion configuration to the one or more memory arrays.

In a fourth aspect, alone or in combination with one or more of the first through third aspects, the method 600 includes obtaining, from the host system and via a second bus, a command indicating that the memory system is to provide the second data to the host system, inverting, based on a second inversion configuration, one or more portions of the second data to generate third data, and providing, to the host system, a second message comprising the third data and the second inversion configuration.

In a fifth aspect, alone or in combination with one or more of the first through fourth aspects, the method 600 includes generating second link parity information associated with the third data and the second inversion configuration, wherein the second message further comprises the second link parity information.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

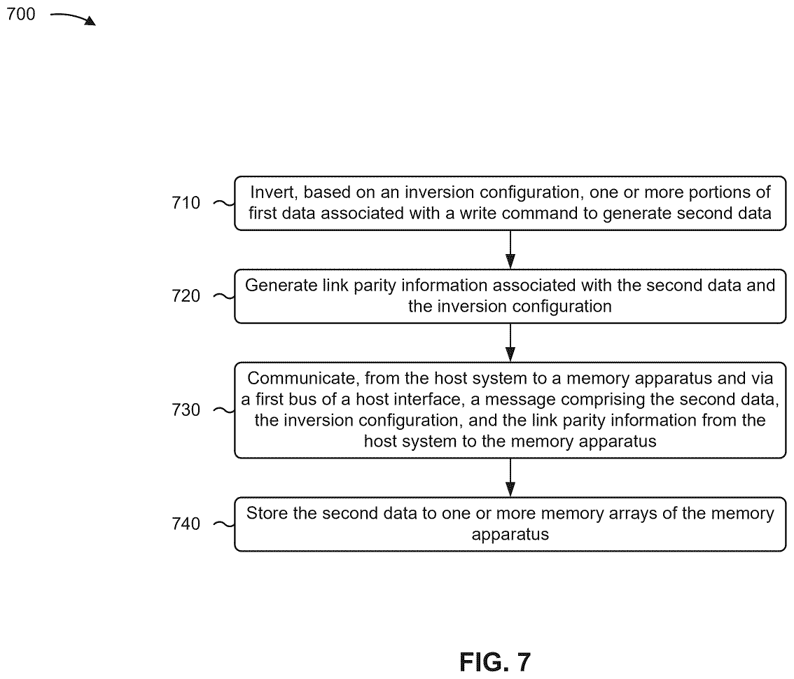

FIG. 7 is a flowchart of an example method 700 associated with signaling that includes inversion information and link parity information. In some implementations, a system (e.g., the system 100 and/or the system 200) may perform or may be configured to perform the method 700. Additionally, or alternatively, one or more components of the system (e.g., a host system 105, a memory system 110, a memory system controller 115, one or more memory devices 120, one or more local controllers 125, one or more memory arrays 130, a host interface 140, one or more memory interfaces 145, a host system 205, a memory system 210, one or more interfaces 215, one or more memory devices 220, one or more sub-interfaces 225, one or more memory arrays 230, one or more memory arrays 235, one or more registers 240, a host system 405, and/or a memory apparatus 410) may perform or may be configured to perform the method 700. Thus, means for performing the method 700 may include the system and/or one or more components of the system. Additionally, or alternatively, a non-transitory computer-readable medium may store one or more instructions that, when executed by the system, cause the system to perform the method 700.

As shown in FIG. 7, the method 700 may include inverting, based on an inversion configuration, one or more portions of first data associated with a write command to generate second data (block 710). As further shown in FIG. 7, the method 700 may include generating link parity information associated with the second data and the inversion configuration (block 720). As further shown in FIG. 7, the method 700 may include communicating, from the host system to a memory apparatus and via a first bus of a host interface, a message comprising the second data, the inversion configuration, and the link parity information from the host system to the memory apparatus (block 730). As further shown in FIG. 7, the method 700 may include storing the second data to one or more memory arrays of the memory apparatus (block 740).

The method 700 may include additional aspects, such as any single aspect or any combination of aspects described below and/or described in connection with one or more other methods or operations described elsewhere herein.

In a first aspect, the method 700 includes storing the inversion configuration to one or more registers of the memory apparatus.

In a second aspect, alone or in combination with the first aspect, the method 700 includes communicating, from the host system to the memory apparatus and via a second bus of the host interface, a command indicating that the memory apparatus is to store the inversion configuration, and transferring, based on the command, the inversion configuration from the one or more registers to a location of the one or more memory arrays, the location associated with metadata corresponding to the second data.

In a third aspect, alone or in combination with one or more of the first and second aspects, the message further comprises system metadata associated with the data, and the method 700 includes storing, based on the communication of the message, the system metadata to the one or more registers of the memory apparatus, and transferring, based on the command, the system metadata from the one or more registers to the location.

In a fourth aspect, alone or in combination with one or more of the first through third aspects, the method 700 includes communicating, from the host system to the memory apparatus and via a second bus of the host interface, a command to read the second data, and communicating, from the host system to the memory apparatus and via the first bus of the host interface, a second message comprising the second data and the inversion configuration.

In a fifth aspect, alone or in combination with one or more of the first through fourth aspects, the method 700 includes reinverting, by the host system and based on the inversion configuration, one or more portions of the second data to generate the first data.

In a sixth aspect, alone or in combination with one or more of the first through fifth aspects, the method 700 includes generating second link parity information associated with the second data and the inversion configuration, and performing, using the second link parity information, an error control operation on the second data and the inversion configuration.

In a seventh aspect, alone or in combination with one or more of the first through sixth aspects, the method 700 includes communicating, from the host system to the memory apparatus and via a second bus, a command indicating that the memory apparatus is to store the second data.

In an eighth aspect, alone or in combination with one or more of the first through seventh aspects, the method 700 includes performing, using the link parity information, an error control operation on the second data and the inversion configuration, and refraining from storing the link parity information to the one or more memory arrays.

In a ninth aspect, alone or in combination with one or more of the first through eighth aspects, the inversion configuration comprises one or more bits indicating whether respective portions of the one or more portions of the first data are to be inverted.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a host system includes one or more components configured to: invert, based on an inversion configuration, one or more portions of first data associated with a write command to generate second data; generate link parity information associated with the second data and the inversion configuration; and provide, to a memory system and via a first bus, a message comprising the second data, the inversion configuration, and the link parity information.

In some implementations, a memory system includes one or more controllers configured to: obtain, from a host system and via a first bus, a message comprising data, an inversion configuration, and link parity information; perform, using the link parity information, an error correction operation on the data and the inversion configuration; and invert, based on the inversion configuration, one or more portions of the data to generate second data.

In some implementations, a system includes a host system; a memory apparatus; a host interface between the host system and the memory apparatus; and one or more controllers configured to: invert, by the host system and based on an inversion configuration, one or more portions of first data associated with a write command to generate second data; generate, by the host system, link parity information associated with the second data and the inversion configuration; communicate, from the host system to the memory apparatus and via a first bus of the host interface, a message comprising the second data, the inversion configuration, and the link parity information from the host system to the memory apparatus; and store the second data to one or more memory arrays of the memory apparatus.

In some implementations, a method includes inverting, by a host system and based on an inversion configuration, one or more portions of first data associated with a write command to generate second data; generating, by the host system, link parity information associated with the second data and the inversion configuration; and providing, by the host system to a memory system and via a first bus, a message comprising the second data, the inversion configuration, and the link parity information.

In some implementations, a method includes obtaining, by a memory system from a host system and via a first bus, a message comprising data, an inversion configuration, and link parity information; performing, by the memory system and using the link parity information, an error correction operation on the data and the inversion configuration; and inverting, by the memory system and based on the inversion configuration, one or more portions of the data to generate second data.

In some implementations, a method includes inverting, by a host system and based on an inversion configuration, one or more portions of first data associated with a write command to generate second data; generating, by the host system, link parity information associated with the second data and the inversion configuration; communicating, from the host system to a memory apparatus and via a first bus of a host interface, a message comprising the second data, the inversion configuration, and the link parity information from the host system to the memory apparatus; and storing, by the host system, the second data to one or more memory arrays of the memory apparatus.

In some implementations, an apparatus includes means for inverting, based on an inversion configuration, one or more portions of first data associated with a write command to generate second data; means for generating link parity information associated with the second data and the inversion configuration; and means for providing, via a first bus, a message comprising the second data, the inversion configuration, and the link parity information.

In some implementations, an apparatus includes means for obtaining, via a first bus, a message comprising data, an inversion configuration, and link parity information; means for performing, using the link parity information, an error correction operation on the data and the inversion configuration; and means for inverting, based on the inversion configuration, one or more portions of the data to generate second data.

In some implementations, an apparatus includes means for inverting, based on an inversion configuration, one or more portions of first data associated with a write command to generate second data; means for generating link parity information associated with the second data and the inversion configuration; means for communicating, from the host system to a memory apparatus and via a first bus of a host interface, a message comprising the second data, the inversion configuration, and the link parity information from the host system to the memory apparatus; and means for storing the second data to one or more memory arrays of the memory apparatus.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A host system, comprising:
one or more components configured to:
invert, based on an inversion configuration, one or more portions of first data to generate second data;
generate link parity information associated with the second data and the inversion configuration; and
provide, to a memory system and via a first bus, a message comprising the second data, the inversion configuration, and the link parity information.

2. The host system of claim 1, wherein the one or more components are further configured to:
provide, to the memory system, a command indicating that the memory system is to store the inversion configuration to a location associated with metadata corresponding to the second data.

3. The host system of claim 1, wherein the one or more components are further configured to:
provide, to the memory system and via a second bus, a command indicating that the memory system is to provide the second data and the inversion configuration to the host system; and
obtain, from the memory system and via the first bus, a second message comprising the second data and the inversion configuration.

4. The host system of claim 3, wherein the one or more components are further configured to:
reinvert the one or more portions of the second data based on the inversion configuration.

5. The host system of claim 3, wherein the second message further comprises second link parity information associated with the second data and the inversion configuration, and wherein the one or more components are further configured to:
perform, using the second link parity information, an error control operation on the second data and the inversion configuration.

6. The host system of claim 1, wherein the one or more components are further configured to:
provide, to the memory system and via a second bus different than the first bus, a command indicating that the memory system is to store the second data.

7. The host system of claim 1, wherein the inversion configuration comprises one or more bits indicating whether respective portions of the one or more portions of the first data are to be inverted.

8. The host system of claim 1, wherein the first bus comprises one or more pins and wherein, to provide the message to the memory system, the one or more components are configured to:
transmit a subset of the second data to the memory system via a first pin of the one or more pins; and
transmit a subset of the inversion configuration to the memory system via the first pin.

9. A memory system, comprising:
one or more controllers configured to:
obtain, from a host system and via a first bus, a message comprising data, an inversion configuration, and link parity information;
perform, using the link parity information, an error correction operation on the data and the inversion configuration; and
invert, based on the inversion configuration, one or more portions of the data to generate second data.

10. The memory system of claim 9, wherein the one or more controllers are further configured to:
store the second data to one or more memory arrays of the memory system.

11. The memory system of claim 10, wherein the one or more controllers are further configured to:
refrain from storing the link parity information to the one or more memory arrays.

12. The memory system of claim 10, wherein the one or more controllers are further configured to:
refrain from storing the inversion configuration to the one or more memory arrays.

13. The memory system of claim 9, wherein the one or more controllers are further configured to:
obtain, from the host system and via a second bus, a command indicating that the memory system is to provide the second data to the host system;
invert, based on a second inversion configuration, one or more portions of the second data to generate third data; and
provide, to the host system, a second message comprising the third data and the second inversion configuration.

14. The memory system of claim 13, wherein the one or more controllers are further configured to:
generate second link parity information associated with the third data and the second inversion configuration, wherein the second message further comprises the second link parity information.

15. A system, comprising:
a host system;
a memory apparatus;
a host interface between the host system and the memory apparatus; and
one or more controllers configured to:
invert, by the host system and based on an inversion configuration, one or more portions of first data to generate second data;
generate, by the host system, link parity information associated with the second data and the inversion configuration;
communicate, from the host system to the memory apparatus and via a first bus of the host interface, a message comprising the second data, the inversion configuration, and the link parity information from the host system to the memory apparatus; and
store the second data to one or more memory arrays of the memory apparatus.

16. The system of claim 15, wherein the one or more controllers are further configured to:
store the inversion configuration to one or more registers of the memory apparatus.

17. The system of claim 16, wherein the one or more controllers are further configured to:
communicate, from the host system to the memory apparatus and via a second bus of the host interface, a command indicating that the memory apparatus is to store the inversion configuration; and
transfer, based on the command, the inversion configuration from the one or more registers to a location of the one or more memory arrays, the location associated with metadata corresponding to the second data.

18. The system of claim 17, wherein the message further comprises system metadata associated with the data, and wherein the one or more controllers are further configured to:
store, based on the communication of the message, the system metadata to the one or more registers of the memory apparatus; and
transfer, based on the command, the system metadata from the one or more registers to the location.

19. The system of claim 15, wherein the one or more controllers are further configured to:
communicate, from the host system to the memory apparatus and via a second bus of the host interface, a command to read the second data; and
communicate, from the host system to the memory apparatus and via the first bus of the host interface, a second message comprising the second data and the inversion configuration.

20. The system of claim 19, wherein the one or more controllers are further configured to:
reinvert, by the host system and based on the inversion configuration, one or more portions of the second data to generate the first data.

21. The system of claim 19, wherein the one or more controllers are further configured to:
generate, by the memory apparatus, second link parity information associated with the second data and the inversion configuration; and
perform, by the host system and using the second link parity information, an error control operation on the second data and the inversion configuration.

22. The system of claim 15, wherein the one or more controllers are further configured to:
communicate, from the host system to the memory apparatus and via a second bus, a command indicating that the memory apparatus is to store the second data.

23. The system of claim 15, wherein the one or more controllers are further configured to:
perform, by the memory apparatus and using the link parity information, an error control operation on the second data and the inversion configuration; and
refrain from storing the link parity information to the one or more memory arrays.

24. The system of claim 15, wherein the inversion configuration comprises one or more bits indicating whether respective portions of the one or more portions of the first data are to be inverted.
